(19) United States
(12) Patent Application Publication
(10) Pub. No.: US 2015/0169075 A1
(43) Pub. Date: Jun. 18, 2015

(54) Three-Dimensional Gesture Remote Control

(71) Applicant: Jason Kelly Peixoto, Phoenix, AZ (US)

(72) Inventor: Jason Kelly Peixoto, Phoenix, AZ (US)

(21) Appl. No.: 14/569,217

(22) Filed: Dec. 12, 2014

Related U.S. Application Data
(60) Provisional application No. 61/915,778, filed on Dec. 13, 2013.

(51) Int. Cl. G06F 3/01; G06F 3/041

(52) U.S. Cl. CPC G06F 3/017; G06F 3/041

(57) ABSTRACT

A three-dimensional remote control for operating external electronic devices. A three-dimensional gesture sensor is positioned within a controller casing having a touchscreen, wherein user motions through a three-dimensional space above the touchscreen are detected by the three-dimensional gesture sensor. A user motion is associated with an execution command for an external electronic device, wherein the user motion and execution command are stored on a memory device of a communications module. A microcontroller analyzes signals from the three-dimensional gesture sensor with data stored on the memory device to determine the execution command. The execution command is then sent to the external electronic device to carry out the appropriate action on the external electronic device. The remote control is synched to the external electronic device through the communications module; either wirelessly via a transceiver or through a wired connection via a device connector port.

The current application claims a priority to the U.S. Provisional Patent application Ser. No. 61/915,778 filed on Dec. 13, 2013.

### FIELD OF THE INVENTION

The present invention relates generally to remote controls for external electronic devices. More specifically, the present invention is a wearable remote control that allows users to control external electronic devices via three-dimensional gestures.

### BACKGROUND OF THE INVENTION

The rapid advancement of electronic technology has led to the corresponding development of various remote control technologies. It is now possible to utilize devices with touchscreen user interfaces as remote controls for external devices in lieu of traditional remote controls with physical buttons. These remote controls often require the use of specific applications or programs in order to function in sync with the controlled devices. When installed, these applications or programs provide a user with a touchscreen user interface with multiple actions and functions available to the user. In addition to remote control touchscreen technology, voice control technology allows a user to manage an external device via voice commands received through an input device such as a microphone. In addition to allowing basic functions such as turning a device on or off, voice commands are capable of functions such as inputting and initiating spoken search queries as well as initiating playback of media. Finally, gesture recognition technology allows users to control devices through body motion. Gesture recognition generally involves the use of a handheld or wearable external electronic device with sensor technology capable of converting user gestures to control actions or functions. The handheld or wearable control device serves as an extension of the user's body with performed gestures captured and converted to inputted control actions and functions. The present invention seeks to enhance and improve upon current remote control technology for external devices.

Therefore it is the object of the present invention to provide a remote control for external electronic devices that translates inputted user three-dimensional gestures and/or touch into control actions or functions. The remote control is used to operate various external electronic devices such as computers, televisions, home appliances, machines, security systems, car electronics systems, and more. The remote control is universally wearable utilizing a variety of attachment accessories including, but not limited to, wristbands, armbands, headbands, and similar accessories. The remote control is also capable of functioning as a standalone remote control when held and operated directly by the user, serving as an extension of the user's body. In the preferred embodiment of the present invention, the remote control comprises a three-dimensional gesture sensor, a touchscreen (providing a physical and digital user interface), a communications module, a power source, a device connector port, and additional (optional) sensors such as accelerometers. As previously discussed, the remote control may be utilized in conjunction with wearable accessories as well. The remote control is synced with an external device. Additionally, the user is able to program the remote control by associating inputted gestures with actions and functions performed on or by the external device. Gestures generally include remote control movement in a three-dimensional space such as, but not limited to, tapping motions, swiping motions, and drawing of shapes. The user may also program unique gestures and/or sequences of gestures as well. In the preferred embodiment of the present invention, the remote control comprises a touchscreen providing both a physical and digital user interface.

### BRIEF DESCRIPTION OF THE DRAWINGS

FIG. 1 is a perspective view of the present invention.

FIG. 2 is a top plan view of the present invention displaying the three-dimensional gesture sensor, power source, communications module, and additional sensor positioned within the controller casing.

FIG. 3 is a perspective view of the present invention having an attachment accessory.

FIG. 4 is a perspective view of the controller casing being positioned within and removably attached to the attachment accessory.

FIG. 5 is a perspective view wherein the strap assembly is permanently affixed to the controller casing.

FIG. 6 is a diagram wherein the present invention is wirelessly connected to an external electronic device, and wherein three-dimensional gestures are used to manipulate the external electronic device.

FIG. 7 is a diagram wherein the present invention is communicably coupled to an external electronic device via a wired connection through the device connector port, and wherein three-dimensional gestures are used to manipulate the external electronic device; and

FIG. 8 is a diagram thereof, wherein the present invention is wirelessly connected to the external electronic device, and wherein three-dimensional gestures are used to manipulate the external electronic device.

FIG. 9 is a diagram wherein the present invention is integrated into an access security system, and wherein three-dimensional gestures are used to manipulate the external electronic device.

FIG. 10 is a diagram wherein three-dimensional gestures inputted through the present invention are used to manipulate a hologram generated by the present invention.

FIG. 11 is a diagram wherein three-dimensional gestures are used to execute functions programmed into the present invention.

FIG. 12 is a diagram depicting the electronic connections of the communications module.

FIG. 13 is a diagram depicting the electrical connections of the power source.

FIG. 14 is a flowchart describing steps for programming and recognizing three-dimensional gestures to control the external electronic device.

FIG. 15 is a flowchart describing steps for programming and recognizing user inputs through the touchscreen.

### DETAIL DESCRIPTIONS OF THE INVENTION

All illustrations of the drawings are for the purpose of describing selected versions of the present invention and are not intended to limit the scope of the present invention.

The present invention is a three-dimensional remote control for operating external electronic devices through the conversion of three-dimensional gestures and/or touch to control actions and functions performed on or by the external devices. The present invention comprises a controller casing 10, a three-dimensional gesture sensor 20, a communications module 30, a power source 40, and a device connector port 50. An attachment accessory 70 can also be utilized, wherein the three-dimensional remote control is wearable by a user via the attachment accessory 70. The present invention can also be integrated into electronics systems, such as automobile control panels, door access panels, point of sale devices, etc.

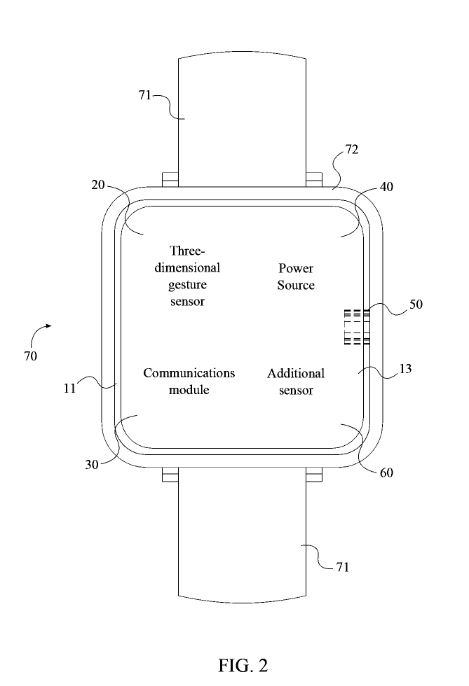

In reference to FIG. 2, the controller casing 10 provides a housing for the three-dimensional gesture sensor 20, the communications module 30, the power source 40, and the device connector port 50. The controller casing 10 comprises a lateral wall 11, a controller base 12, and a touchscreen 13. The controller base 12 is perimetrically connected to the lateral wall 11, while the touchscreen 13 is adjacently connected to the lateral wall 11 opposite the controller base 12. The controller casing 10 can be fitted to the attachment accessory 70 as desired by the user, depending on the application of the present invention. The device connector port 50 traverses through the controller casing 10; more specifically, through the lateral wall 11.

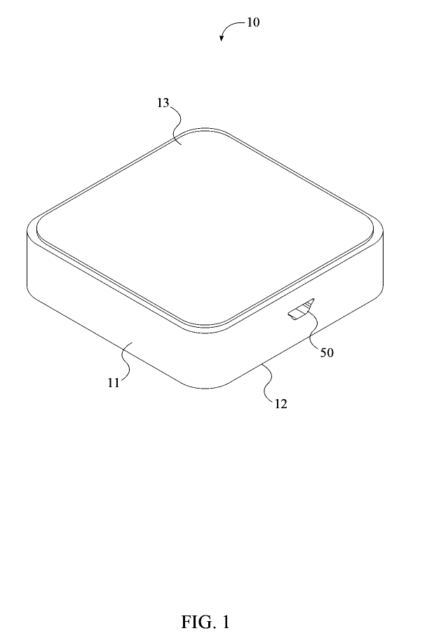

In reference to FIG. 1, the touchscreen 13 provides a physical user interface and a digital user interface through which the user may interact with the present invention. The physical user interface of the touchscreen 13 allows the user to manually operate the present invention by pressing sections of the touchscreen 13, swiping across the touchscreen 13, etc. The digital user interface of the touchscreen 13 displays system information to the user, such as battery life, and provides a display of controls for synching with and manipulating the external electronic device to which the present invention is communicably coupled. The touchscreen 13 may also be utilized to program the present invention directly by associating inputted gestures with actions and functions performed on or by the external electronic device.

In reference to FIG. 2, the three-dimensional gesture sensor 20 is positioned within the controller casing 10 and is capable of determining the position, orientation, and movement of the user operating the present invention. The three-dimensional gesture sensor 20 is oriented such that movement through a three-dimensional space about the touchscreen 13 is tracked. The three-dimensional gesture sensor 20 can use any known technology to track the movement of the user including, but not limited to, camera tracking, infrared tracking, or magnetic field manipulation.

In further reference to FIG. 2, the present invention may further comprise an additional sensor 60 for tracking other user inputs. For example, the additional sensor 60 may be an accelerometer, such that the present invention can be tilted in a specific manner in order to control the external electronic device. Similar to the three-dimensional gesture sensor 20, the additional sensor 60 is positioned within the controller casing 10. It is also possible for more than one additional sensor 60 to be integrated into the present invention. Both the three-dimensional gesture sensor 20 and the additional sensor 60 may be deactivated as needed in order to prevent unwanted gesture input during operation of the external device.

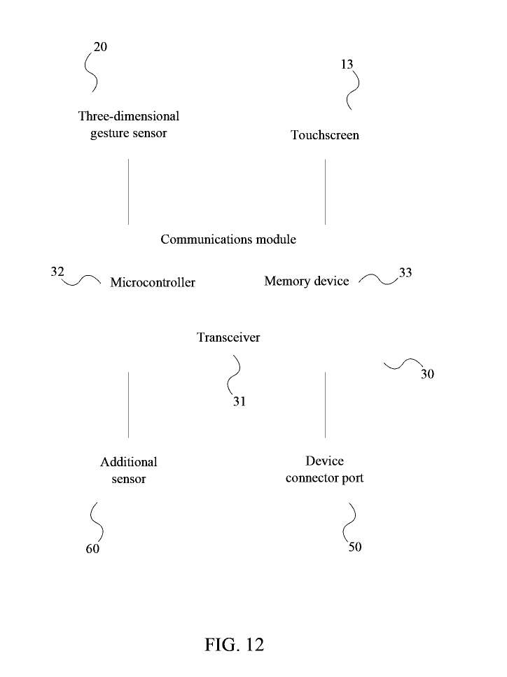

In reference to FIG. 2 and FIG. 12, the communications module 30 allows the present invention to be synched to the external electronic device that is to be controlled. The communications module 30 is positioned within the controller casing 10 and is electronically connected to the three-dimensional gesture sensor 20, the touchscreen 13, the device connector port 50, and the additional sensor 60 if used. The communications module 30 may use any known protocol or technology to synch with the external electronic device and comprises a memory device 33, a microcontroller 32, and a transceiver 31. The transceiver 31 allows the present invention to be wirelessly synched with the external electronic device, while the device connector port 50 allows the present invention to be synched to the external electronic device through a wired connection. The memory device 33 allows user defined commands to be programmed into the present invention, while the microcontroller 32 analyzes user inputs through the touchscreen 13, the three-dimensional gesture sensor 20, and the additional sensor 60 in order to determine corresponding commands for controlling the external electronic device.

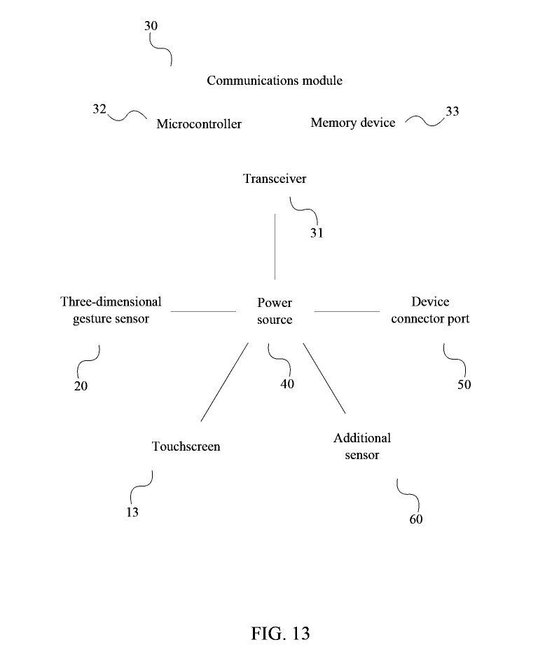

In reference to FIG. 2 and FIG. 13, the power source 40 is positioned within the controller casing 10 and is electrically connected to the touchscreen 13, the three-dimensional gesture sensor 20, the communications module 30, the device connector port 50, and the additional sensor 60 if used. The power source 40 provides current to the touchscreen 13, the three-dimensional gesture sensor 20, and the communications module 30 (and the additional sensor 60 if used) in order to power the present invention. In the preferred embodiment of the present invention, the power source 40 is a rechargeable battery that can be recharged through the device connector port 50. As such, the device connector port 50 can utilize any protocol that allows for both energy and data transfer, such as through a universal serial bus (USB) connector, micro-USB connector, or other similar protocol. It is also possible for the power source 40 to be a non-rechargeable battery that can be replaced through an access panel in the controller casing 10.

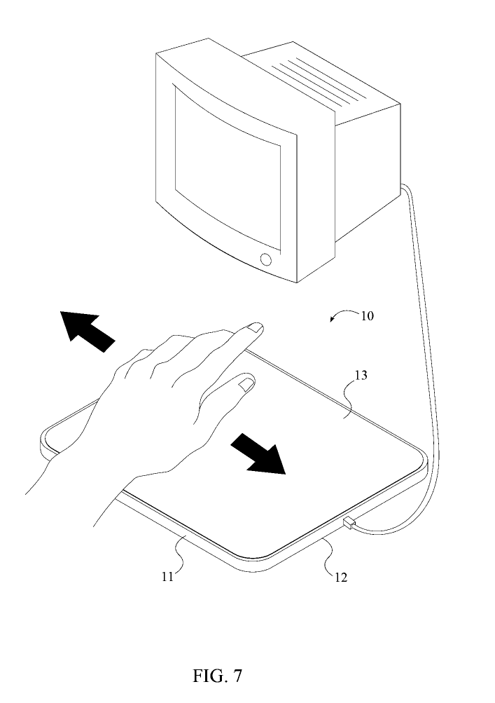

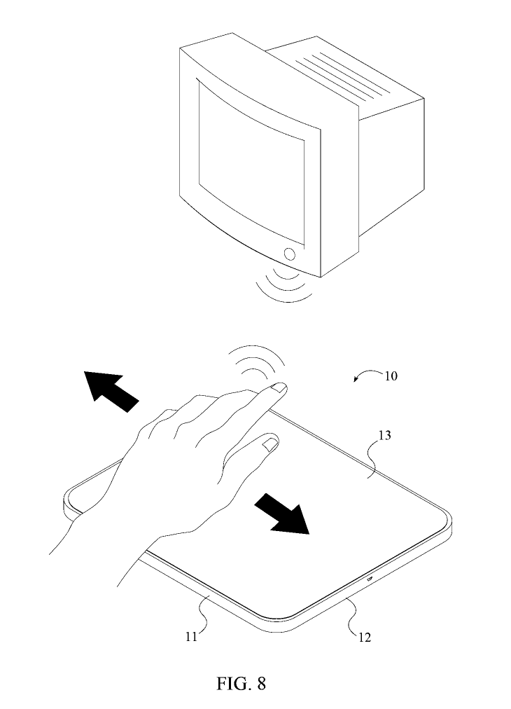

The external electronic device with which the present invention is utilized may include, but is not limited to, a computer, television, home appliance, car electronics system, or control systems. several different applications. Depending on the application, the present invention may be used with or without the attachment accessory 70. When used without the attachment accessory 70, the controller casing 10 can be physically handled by the user in order to utilize the touchscreen 13 and the additional sensor 60, in addition to making gestures recognizable by the three-dimensional gesture sensor 20. This allows the user to utilize the present invention in a manner similar to a computer mouse with the additional utilization of the three-dimensional space above the touchscreen 13, as depicted in FIG. 7-8. In such an application, the present invention serves as a replacement for the traditional computer mouse used to control the external electronic device.

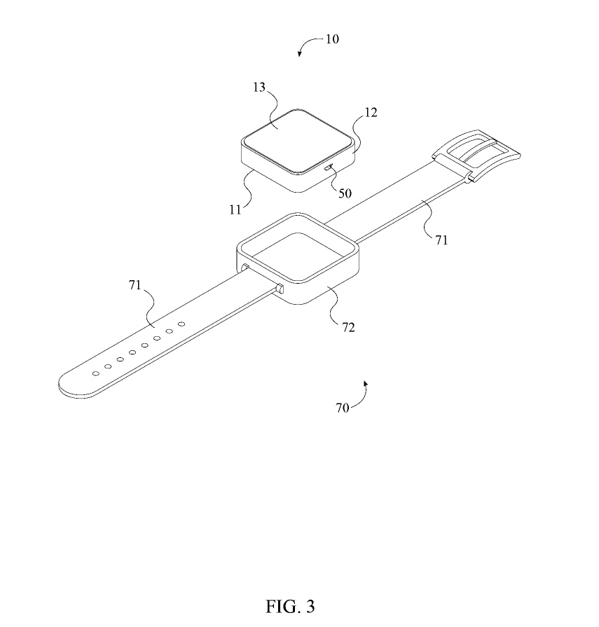

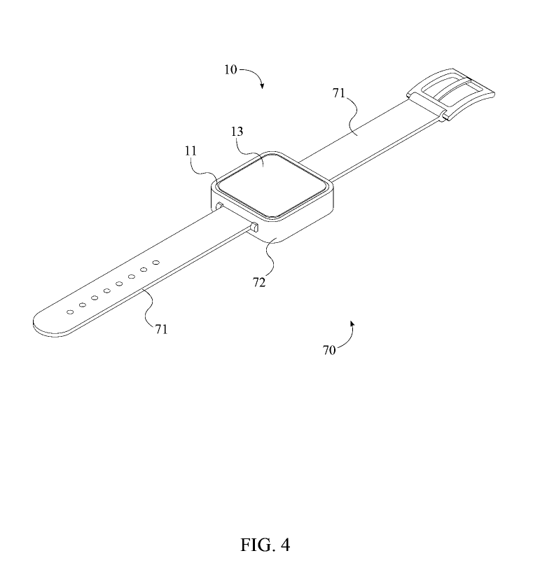

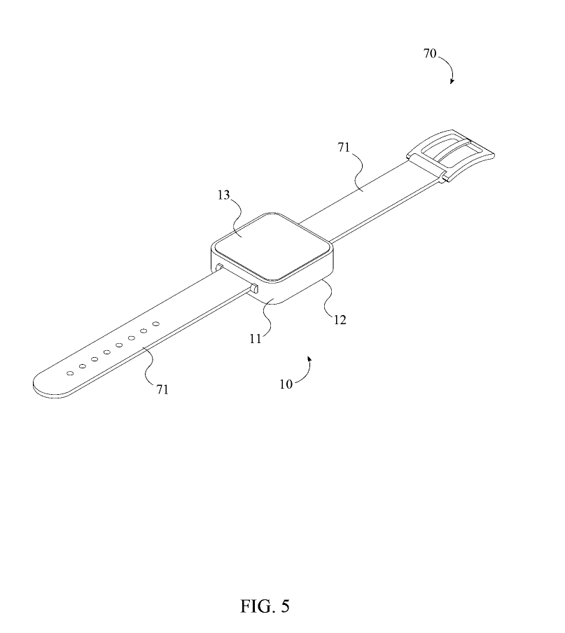

In other applications it may be beneficial for the present invention to be worn by the user. In such a case, the attachment accessory 70 may include a strap assembly 71 through which the present invention can be secured to the user. For example, the strap assembly 71 can be configured to form a wristband, armband, headband, or belt. In reference to FIG. 5, in one embodiment the strap assembly 71 is adjacently connected to the controller casing 10, wherein the strap assembly 71 is permanently fixed to the controller casing 10. In reference to FIG. 3-4, in another embodiment, the attachment accessory 70 may further include a controller receiver 72, wherein the strap assembly 71 is adjacently and permanently connected to the controller receiver 72. The controller casing 10 is then adjacently attached to the controller receiver 72, wherein the controller casing 10 can be removed. The controller receiver 72 may be an encompassing case, provide a snap attachment, or provide any other suitable means of temporarily attaching the controller casing 10.

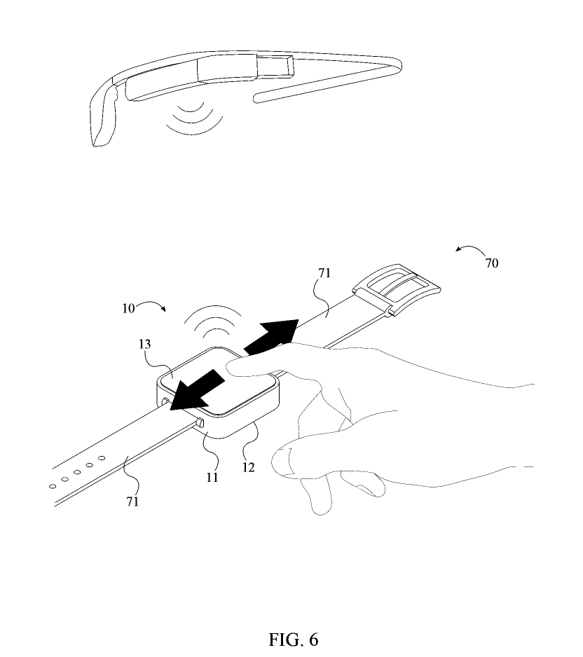

The attachment accessory 70 comprising the strap assembly 71 and the controller receiver 72 allows the present invention to readily be utilized with a number of different devices. For example, with the attachment accessory 70 the present invention could be used to control a wearable electronic headset, as depicted in FIG. 6. The controller casing 10 could then be removed and the present invention used as a computer mouse. The present invention need only be synched with the external electronic device currently being operated. Gestures programmed into the communications module 30, and the corresponding control actions or functions, are associated with the appropriate external device. As such, the present invention recognizes the external electronic device during syncing and the user is not required to reprogram the gestures and control actions or functions as the present invention is used across multiple devices.

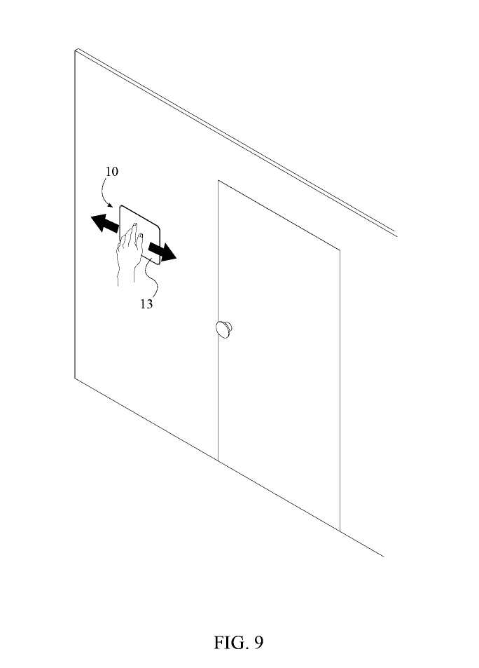

The remote control of the present invention is not limited with respect to size, as different sizes may be necessary for different applications of the present invention. In embodiments of the present invention utilizing the attachment accessory 70, wherein the present invention is wearable, a smaller size is more appropriate, such as that depicted in FIG. 6. For other applications where a wider range of user motions is required, a larger embodiment of the present invention may be implemented. In reference to FIG. 7-9, such larger use applications may include, but are not limited to, a three-dimensional trackpad for computer modeling, a three-dimensional wall-mounted control panel, or a three-dimensional automobile control panel.

In order to control the external electronic device of the user's choice via three-dimensional gestures, the user syncs the present invention with the external electronic device. The touchscreen 13, the three-dimensional gesture sensor 20, and the additional sensor 60 can be temporarily deactivated by the user, if the user wishes to program specific regions of the touchscreen 13, specific gestures to be recognized, or specific movements of the present invention, in order to avoid accidental input during programming. Gestures and other inputs that are programmed by the user are stored on the memory device 33 with the associated commands for controlling the external electronic device. As previously discussed, programming may be done directly through the touchscreen 13 of the present invention. Alternatively, the present invention can be a connected to an external device such as a computer, through the device connector port 50 or the transceiver 31, and programmed through an application operated on the external electronic device.

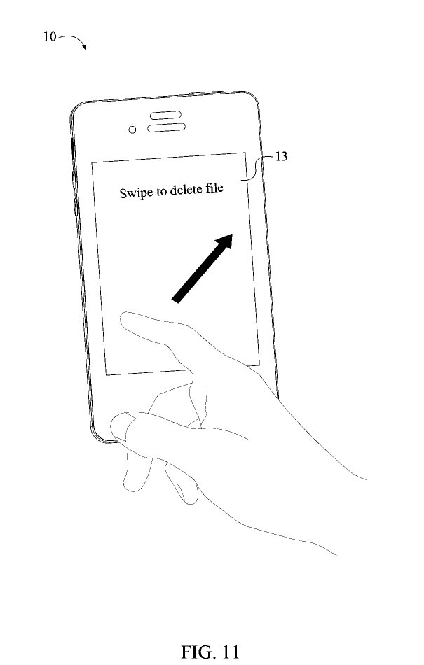

In addition to controlling the external electronic device, gestures inputted through the three-dimensional gesture sensor 20 can also be used to control functions of the present invention itself, wherein the present invention has the ability to run programs directly stored on the memory device 33. In such embodiments, the present invention may further include features common to smartphones and smartwatches, such as making calls, sending text messages, or checking email, wherein such features may be controlled via inputs through the three dimensional gesture sensor 20. For example, gestures through the three-dimensional space can be used to switch screens on the touchscreen 13, check the battery status, connect to or disconnect from the external electronic device, open a program, or delete a file, as depicted in FIG. 11.

The user may designate various regions of the touchscreen 13 and the three-dimensional space above the touchscreen 13 for physical touch inputs and three-dimensional gesture inputs respectively. The following are example inputs and the corresponding example control actions or functions, and are not intended to limit the scope of the functionality of the present invention. A swipe to the left or right through the three-dimensional space about an x-axis can be used to change slides of a presentation, or the channel on a television; movement up and down through the three-dimensional space about a y-axis can be used to scroll up or down in a computer document, or increase and decrease the volume of a media player; forward and backward movement through the three-dimensional space about a z-axis can be used to zoom in and out of an image; drawing a slash mark or ‘x’ through the three-dimensional space can be used to delete a file; a quick tap on the touchscreen 13 can be used to make a selection in a menu, while a long tap can be used to open files; tapping a programmed region of the touchscreen 13 to execute a specific function, program, etc.; rotating the present invention to change the display orientation of an image from portrait to landscape and vice versa.

During programming, the user is able to specify details such as gesture speed and gesture range of motion required when performing a specific action or function. In addition to single gestures, the user may program specific combinations of gestures as well in order to initiate various control actions or functions performed on or by the external electronic device. Programmed gestures and their corresponding control actions or functions are associated with the appropriate external electronic device and stored on the memory device 33. When a user motion or a user input is detected through the three-dimensional gesture sensor 20, the touchscreen 13, or the additional sensor 60, the microcontroller 32 determines the appropriate execution command to be sent to the external electronic device according to the information stored on the memory device 33.

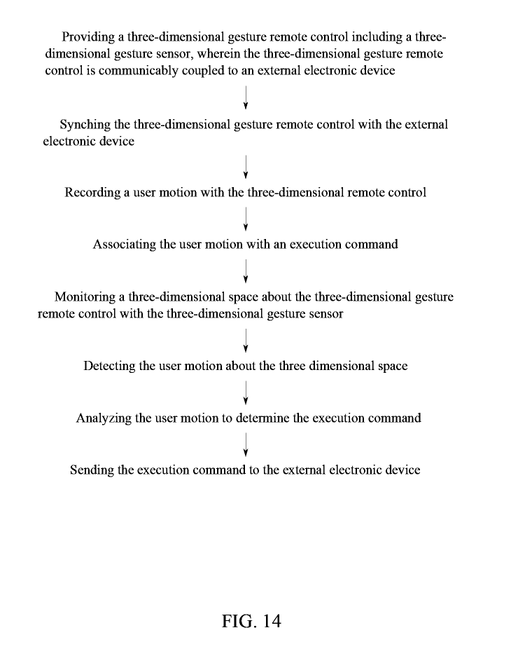

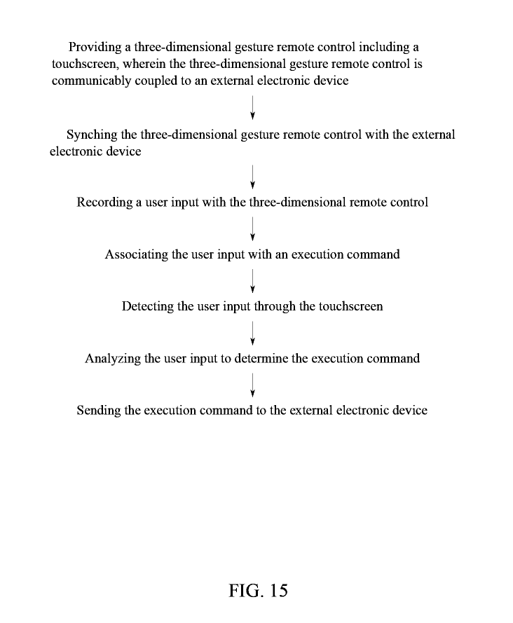

The following is to describe the overall process for programming the present invention and controlling the external electronic device with the present invention. In reference to FIG. 14-15, the three-dimensional remote control is first synched with the external electronic device, either wirelessly through the transmitter or through a wired connection via the device connector port 50. Once synched, the user can then program commands into the memory device 33 using either the interface provided by the touchscreen 13 or the interface of an application operated on the external electronic device. The user can then program three-dimensional gestures, wherein the user motion about the three-dimensional space above the touchscreen 13 is recorded by the three-dimensional gesture sensor 20 and stored on the memory device 33. The user motion is then associated with the execution command chosen by the user, wherein the execution command is stored with the user motion on the memory device 33. A user input via the touchscreen 13 can also be programmed in the same manner.

In further reference to FIG. 14-15, once the present invention has been programmed according to the needs of the user, the three-dimensional gesture sensor 20 monitors the three-dimensional space about the touchscreen 13. When the three-dimensional gesture sensor 20 detects the user motion within the three-dimensional space, the user motion is recorded. The user motion is then analyzed by signals sent from the three-dimensional gesture sensor 20 to the microcontroller 32 and the user motion is identified within the memory device 33 in order to determine the execution command associated with the user motion. The execution command is then sent to the external electronic device, wherein the execution command is performed on or by the external electronic device. Similarly, when the user input is received through the touchscreen 13, the user input is analyzed by signals sent from the touchscreen 13 to the microcontroller 32 in order to determine the execution command associated with the user input.

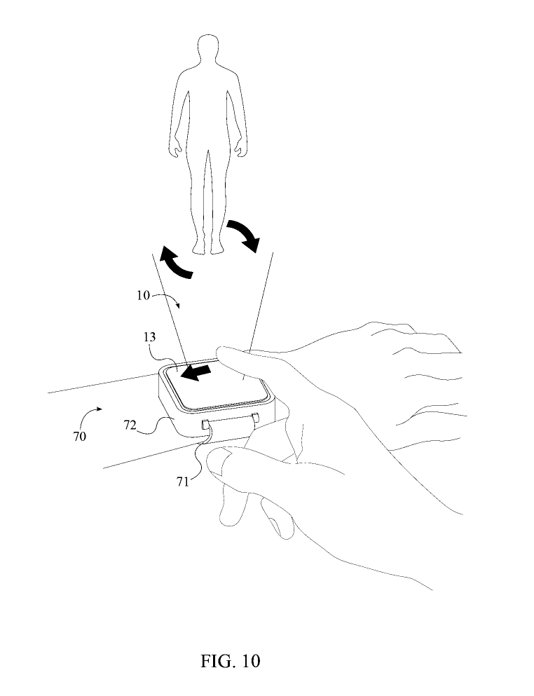

The present invention can be applied to a plethora of applications in addition to those described above. The following is intended to highlight additional potential fields of use of the present invention and is not intended to limit the application of the present invention. The present invention can be used to control and interact with equipment, specimens, or other subjects without risking contamination in the medical and scientific field; used to manage robotic sensor activity, control the movement of a robot, and other robotics applications; manage equipment in harsh/dangerous conditions without putting personnel in harm's way, and other industrial applications; grant access by utilizing a unique sequence of gestures in lieu of or in conjunction with traditionally used pass codes, access, cards, etc.; provide a means for allowing the elderly or disabled to conveniently manage devices and equipment; provide a replacement or supplemental user interface to control systems with switches, sliders, knobs, etc.; and provide controls for manipulating three-dimensional holograms generated either from the present invention, as depicted in FIG. 10, or the external electronic device.

Although the invention has been explained in relation to its preferred embodiment, it is to be understood that many other possible modifications and variations can be made without departing from the spirit and scope of the invention as hereinafter claimed.

What is claimed is:

1. A three-dimensional gesture remote control comprises:
a three-dimensional gesture sensor;
a communications module;
a power source;
a controller casing comprises a lateral wall, a controller base, and a touchscreen;
a device connector port being positioned through the controller casing;
the controller base being perimetrically connected to the lateral wall;
the touchscreen being adjacently connected to the lateral wall opposite the controller base;
the three-dimensional gesture sensor, the communications module, and the power source being positioned within the controller casing;
the touchscreen, the three-dimensional gesture sensor, the communications module, and the device connector port being electrically connected to the power source; and
the touchscreen, the three-dimensional gesture sensor and the device connector port being electronically connected to the communications module.

2. The three-dimensional gesture remote control as claimed in claim 1 comprises:
an additional sensor;
the additional sensor being positioned within the controller casing;
the additional sensor being electrically connected to the power source; and
the additional sensor being electronically connected to the processing unit.

3. The three-dimensional gesture sensor as claimed in claim 2, wherein the additional sensor is an accelerometer.

4. The three-dimensional gesture remote control as claimed in claim 1, wherein the communications module comprises a microcontroller.

5. The three-dimensional gesture remote control as claimed in claim 1, wherein the communications module comprises a memory device.

6. The three-dimensional gesture remote control as claimed in claim 1, wherein the communications module comprises a transceiver.

7. The three-dimensional gesture remote control as claimed in claim 1 comprises:
a controller receiver;
a strap assembly;
the controller casing being adjacently attached to the controller receiver; and
the strap assembly being adjacently connected to the controller receiver.

8. The three-dimensional gesture remote control as claimed in claim 1 comprises:
a strap assembly; and
the strap assembly being adjacently connected to the controller casing.

9. The three-dimensional gesture remote control as claimed in claim 1 comprises:
the device connector port being positioned through the lateral wall.

10. A three-dimensional gesture remote control comprises:
a three-dimensional gesture sensor;
a power source;
a controller receiver;
a strap assembly;
a communications module comprises a transceiver, wherein the communications module is communicably coupled to an external electronic device;
a controller casing comprises a lateral wall, a controller base, and a touchscreen;
a device connector port being positioned through the controller casing;
the controller base being perimetrically connected to the lateral wall;
the touchscreen being adjacently connected to the lateral wall opposite the controller base;
the three-dimensional gesture sensor, the communications module, and the power source being positioned within the controller casing;
the touchscreen, the three-dimensional gesture sensor, the communications module, and the device connector port being electrically connected to the power source;
the touchscreen, the three-dimensional gesture sensor and the device connector port being electronically connected to the communications module;
the controller casing being adjacently attached to the controller receiver; and
the strap assembly being adjacently connected to the controller receiver.

11. The three-dimensional gesture remote control as claimed in claim 10 comprises:
an additional sensor;
the additional sensor being positioned within the controller casing;
the additional sensor being electrically connected to the power source; and
the additional sensor being electronically connected to the processing unit.

12. The three-dimensional gesture sensor as claimed in claim 11, wherein the additional sensor is an accelerometer.

13. The three-dimensional gesture remote control as claimed in claim 10, wherein the communications module comprises a microcontroller.

14. The three-dimensional gesture remote control as claimed in claim 10, wherein the communications module comprises a memory device.

15. The three-dimensional gesture remote control as claimed in claim 10 comprises:
the device connector port being positioned through the lateral wall.

16. A method for controlling an electronic device using three-dimensional gestures by executing computer-executable instructions stored on a non-transitory computer-readable medium, the method comprises the steps of:
providing a three-dimensional gesture remote control including a three-dimensional gesture sensor, wherein the three-dimensional gesture remote control is communicably coupled to an external electronic device;
synching the three-dimensional gesture remote control with the external electronic device;
monitoring a three-dimensional space about the three-dimensional gesture remote control with the three-dimensional gesture sensor;
detecting a user motion about the three-dimensional space;
analyzing the user motion to determine an execution command; and
sending the execution command to the external electronic device.

17. The method for controlling an electronic device using three-dimensional gestures by executing computer-executable instructions stored on a non-transitory computer-readable medium, the method as claimed in claim 16 further comprises the steps of:
providing a touchscreen for the three-dimensional gesture remote control;
receiving a user input through the touchscreen; and
analyzing the user input to determine the execution command.

18. The method for controlling an electronic device using three-dimensional gestures by executing computer-executable instructions stored on a non-transitory computer-readable medium, the method as claimed in claim 16 further comprises the steps of:
recording the user motion with the three-dimensional gesture sensor; and
associating the user motion with the execution command.

19. The method for controlling an electronic device using three-dimensional gestures by executing computer-executable instructions stored on a non-transitory computer-readable medium, the method as claimed in claim 16, wherein the user motion is a single gesture.

20. The method for controlling an electronic device using three-dimensional gestures by executing computer-executable instructions stored on a non-transitory computer-readable medium, the method as claimed in claim 16, wherein the user motion is a combination of gestures.
